(19) United States
(12) Patent Application Publication
(10) Pub. No.: US 2021/0326724 A1
(43) Pub. Date: Oct. 21, 2021

(54) HYPOTHESIS EVALUATION SYSTEM AND HYPOTHESIS EVALUATION METHOD

(71) Applicant: HITACHI, LTD., Tokyo (JP)

(72) Inventors: Atsushi TOMODA, Tokyo (JP); Hiroyuki NAMBA, Tokyo (JP)

(73) Assignee: HITACHI, LTD., Tokyo (JP)

(21) Appl. No.: 17/190,834

(22) Filed: Mar. 3, 2021

(30) Foreign Application Priority Data
Apr. 21, 2020 (JP) 2020-075620

(51) Int. Cl. G06N 5/04; G06F 11/34

(52) U.S. Cl. CPC G06N 5/04; G06F 11/3466

(57) ABSTRACT

A hypothesis evaluation system evaluates a hypothesis for a work efficiently and appropriately, and is configured to store, for a work whose efficiency is desired to be improved, a hypothesis defined by using, as elements, one or more combinations of a feature amount representing the work and a condition imposed on the feature amount, and a target index of the efficiency, generate a plurality of measures in which a value of the feature amount is set around a threshold that determines a range of the feature amount so as to satisfy the condition, store an estimation value of the efficiency for each of the measures, the estimation value being acquired by executing the measure, compare the estimation value with the target index to determine whether or not the hypothesis is established for each of the measures, and set the threshold based on a result of the determination.

### CROSS-REFERENCE TO RELATED APPLICATION

This application claims priority pursuant to 35 U.S.C. §119 from Japanese Patent Application No. 2020-075620, filed on Apr. 21, 2020, the entire disclosure of which is incorporated herein by reference.

### BACKGROUND

### Technical Field

The present invention relates to a hypothesis evaluation system and a hypothesis evaluation method.

### Related Art

Japanese Patent Application Laid-open Publication No. 2019-79104 discloses a data analysis system configured for a purpose of automatically and efficiently generating a measure for improving business from a new viewpoint. The data analysis system acquires business data including a plurality of attributes related to business from a business system, specifies target data to be analyzed based on a distribution of a related index related to a business evaluation index for evaluating the business, the business evaluation index being a value of the attribute or a value calculated based on the value of the attribute, calculates an awareness feature amount that may contribute to improvement of the business evaluation index by analyzing the target data, generates a measure for improving the business evaluation index based on the awareness feature amount, and outputs data for the generated measure.

In recent years, in a distribution warehouse, products to be handled are becoming more diverse in small quantities. In addition, a constraint on a delivery time from an order to delivery is becoming stricter. It is required to further improve efficiency of warehouse business with a limited number of workers and a limited space.

Regarding a method of improving efficiency of the warehouse business, for example, there is a method in which a prediction model of a work time is generated based on past work performance and business efficiency (KPI: Key Performance Indicator) is estimated using the generated prediction model. According to the method, it is possible to perform prediction with a certain degree of high accuracy, and it is possible to optimize product arrangement based on the prediction model.

However, the number of combinations of product arrangements is enormous, for example, even if one method of arranging products on a shelf is taken. The past work performance used for generation of the prediction model is usually merely obtained for very limited product arrangements from the above combinations. On the other hand, a product arrangement method that has almost no past performance may significantly improve business efficiency. It is effective to actively search for such a product arrangement in order to continuously improve the business efficiency.

In the above-mentioned Japanese publication, the awareness feature amount that may contribute to the improvement of the business evaluation index is calculated, and the measure (hereinafter, referred to as a “hypothesis”) for improving the business evaluation index is generated based on the calculated awareness feature amount.

However, in a case where the number of pieces of business data capturing a phenomenon of improving the business efficiency is very small, the awareness feature amount is merely one in which a certain part of a region, in which the phenomenon occurs, in a feature amount space representing the work is captured so as to include the business data. Even if the measure is executed on a region satisfying a combination of conditions set for the feature amount, an expected effect is not necessarily obtained. Therefore, when the hypothesis that may improve the business efficiency is verified, it is necessary to efficiently and appropriately evaluate the hypothesis.

### SUMMARY

The invention has been made in view of such a background, and an object thereof is to provide a hypothesis evaluation system and a hypothesis evaluation method capable of efficiently and appropriately evaluating a hypothesis.

An aspect of the invention for achieving the above object provides a hypothesis evaluation system implemented using an information processing device. The hypothesis evaluation system is configured to store, for a work whose efficiency is desired to be improved, a hypothesis defined by using, as elements, one or more combinations of a feature amount representing the work and a condition imposed on the feature amount, and a target index of the efficiency, generate a plurality of measures in which a value of the feature amount is set around a threshold that determines a range of the feature amount so as to satisfy the condition, store an estimation value of the efficiency for each of the measures, the estimation value being acquired by executing the measure, compare the estimation value with the target index to determine whether or not the hypothesis is established for each of the measures, and set the threshold based on a result of the determination.

Other problems and methods disclosed by the invention for solving such problems will become apparent from the description of an embodiment and drawings.

According to the invention, the hypothesis can be evaluated efficiently and appropriately.

### BRIEF DESCRIPTION OF THE DRAWINGS

FIG. 1 is a block diagram showing main functions of a hypothesis evaluation system.

FIG. 2 shows an example of a hardware configuration of an information processing device used to implement the hypothesis evaluation system.

FIG. 3A is a plan diagram of a distribution warehouse.

FIG. 3B is a schematic diagram showing a structure of a shelf.

FIG. 4 shows an example of a work instruction.

FIG. 5 shows an example of work performance information.

FIG. 6 shows an example of a product master.

FIG. 7 shows an example of an inventory master.

FIG. 8 shows an example of feature amount information.

FIG. 9 shows an example of hypothesis information.

FIG. 10 shows an example of measure information.

FIG. 11 is a flowchart illustrating measure generation processing.

FIG. 12A shows an example of a work instruction before a content of the measure information is reflected therein.

FIG. 12B shows an example of the work instruction after the content of the measure information is reflected therein.

FIG. 13 is a flowchart illustrating hypothesis evaluation processing.

FIG. 14 is a flowchart illustrating another example of the hypothesis evaluation processing.

FIG. 15A is a graph showing a distribution of samples (performance data) before a threshold is changed.

FIG. 15B is a graph showing the distribution of the samples (the performance data) after the threshold is changed.

### DESCRIPTION OF EMBODIMENTS

Hereinafter, an embodiment will be described with reference to the drawings. In the following description, the same or similar components are denoted by the same reference numerals, and a repetitive description thereof may be omitted. The following description and drawings are examples for explaining the invention, and are omitted and simplified as appropriate for clarification of the description. The invention can be implemented in various other forms. Unless otherwise limited, each component may be singular or plural. When identification information is illustrated, expressions such as “identifier”, “ID” are properly used, but these expressions may be replaced with one another.

A hypothesis evaluation system 1, which is an information processing system shown as an embodiment, is constituted using one or more information processing devices. The hypothesis evaluation system 1 sets, as a hypothesis, a work method by which efficiency of warehouse business may be improved, and evaluates the set hypothesis. Specifically, the hypothesis evaluation system 1 generates a measure that is a work for evaluating the hypothesis, generates a work instruction for instructing execution of the generated measure, evaluates the hypothesis based on information (hereinafter, referred to as “performance data” or “sample”) indicating performance of the work performed according to the generated work instruction, and outputs the evaluation result. The evaluation result is referred to by, for example, a user of the hypothesis evaluation system 1 such as an administrator of the warehouse business. For example, the user refers to the above evaluation result to improve the warehouse business and improve the efficiency of the warehouse business. In addition, the evaluation result is provided to, for example, another information processing system that performs information processing related to improvement and efficiency of the warehouse business.

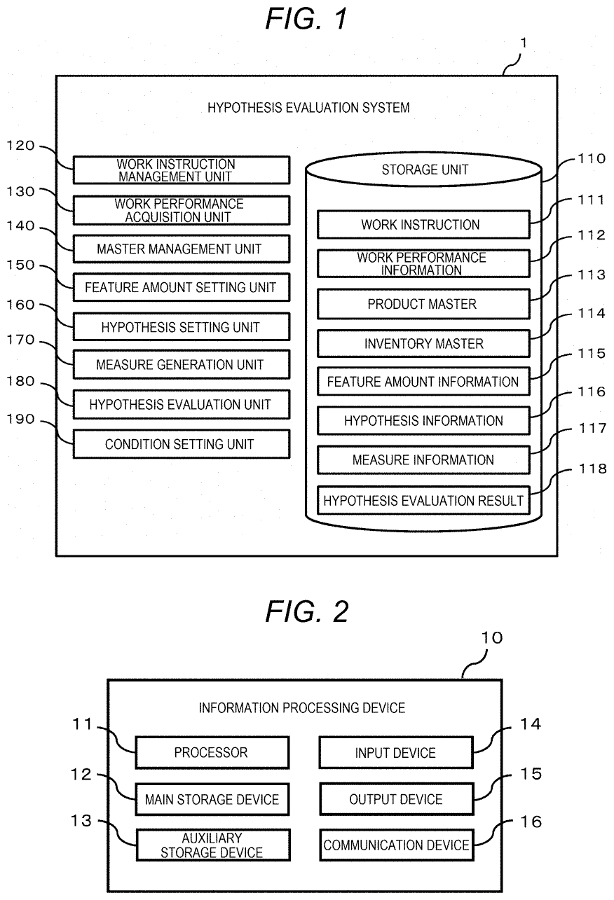

FIG. 1 shows main functions of the hypothesis evaluation system 1. As shown in FIG. 1, the hypothesis evaluation system 1 has functions of a storage unit 110, a work instruction management unit 120, a work performance acquisition unit 130, a master management unit 140, a feature amount setting unit 150, a hypothesis setting unit 160, a measure generation unit 170, a hypothesis evaluation unit 180, and a condition setting unit 190.

Among the above functions, the storage unit 110 stores a work instruction 111, work performance information 112, a product master 113, an inventory master 114, feature amount information 115, hypothesis information 116, measure information 117, and a hypothesis evaluation result 118. The storage unit 110 stores such information (data) as, for example, a database table provided by a database management system (DBMS) or a file provided by a file system.

The work instruction management unit 120 manages the work instruction 111, which is information related to work to be performed by a worker of the warehouse business (work in which the worker is instructed). The work instruction management unit 120 generates the work instruction 111 by performing a dialogue processing with a creator of the work instruction 111 or generates the work instruction 111 automatically. The work instruction management unit 120 also generates the work instruction 111 based on a measure generated by the measure generation unit 170. A use entity of the work instruction 111 does not necessarily be a person, and may be, for example, a robot or a machine that supports the work performed by the worker.

The work performance acquisition unit 130 acquires performance data of the work actually performed according to the work instruction 111, and manages the performance data as the work performance information 112. The performance data may be acquired by being received from the user, or may be acquired from another information processing system that stores and manages the performance data acquired based on information transmitted from a handy terminal or the like carried by the worker or the like.

The master management unit 140 manages the product master 113 that manages product information, which is information related to the product, and the inventory master 114 that manages inventory information, which is information related to the inventory of the product in each shelf. The product information and the inventory information are used, for example, during setting of the hypothesis and setting of the measure.

The feature amount setting unit 150 performs information processing related to setting of the feature amount information 115, which is information related to the feature amount representing work performed in the warehouse business, which is used during setting of the hypothesis, based on the work performance information 112, the product master 113, and the inventory master 114.

The hypothesis setting unit 160 generates the hypothesis based on the feature amount information 115 and manages the generated hypothesis as the hypothesis information 116. The hypothesis is defined, for the work for improving the efficiency, by using, as elements, one or more combinations of a feature amount representing the work and a condition imposed on the feature amount, and a target index of the efficiency.

The measure generation unit 170 generates a measure for evaluating the hypothesis information 116, and manages the generated measure as the measure information 117. The measure generation unit 170 generates a plurality of measures in which a value of the feature amount is set around a threshold that determines a range of the feature amount in which a condition of the feature amount is satisfied.

The hypothesis evaluation unit 180 evaluates the hypothesis based on the work performance information 112 obtained by executing the measures included in the measure information 117, and manages the evaluation result as the hypothesis evaluation result 118.

The condition setting unit 190 updates a content of the hypothesis information 116 as needed based on the hypothesis evaluation result 118.

FIG. 2 shows an example of a hardware configuration of an information processing device used to implement the hypothesis evaluation system 1. An exemplified information processing device 10 includes a processor 11, a main storage device 12, an auxiliary storage device 13, an input device 14, an output device 15, and a communication device 16. All or a part of the information processing device 10 may be implemented by using a virtual information processing resource provided by using a virtualization technique, a process space separation technique, or the like, for example, a virtual server provided by a cloud system. All or a part of the functions provided by the information processing device 10 may also be implemented by, for example, a service provided by the cloud system via an application programming interface (API). The hypothesis evaluation system 1 may be constituted using a plurality of information processing devices 10 communicably connected to one another.

In FIG. 2, the processor 11 is constituted using, for example, a central processing unit (CPU), a micro-processing unit (MPU), a graphics processing unit (GPU), a field programmable gate array (FPGA), an application specific integrated circuit (ASIC), and an artificial intelligence (AI) chip.

The main storage device 12 is a device that stores a program and data, and is, for example, a read only memory (ROM), a random access memory (RAM), and a non-volatile random access memory (NVRAM).

The auxiliary storage device 13 is, for example, a hard disc drive, a solid state drive (SSD), an optical storage device (such as a compact disc (CD), a digital versatile disc (DVD)), a storage system, an IC card, a reading and writing device of a recording medium such as an SD card or an optical recording medium, and a storage domain of a cloud server. The program and data can be read into the auxiliary storage device 13 via a reading device of a recording medium or the communication device 16. The program and data stored in the auxiliary storage device 13 are read into the main storage device 12 as needed.

The input device 14 is an interface that receives input from outside, and is, for example, a keyboard, a mouse, a touch panel, a card reader, a pen input type tablet, and a voice input device.

The output device 15 is an interface that outputs various kinds of information such as a processing process or a processing result. The output device 15 is, for example, a display device (such as a liquid crystal monitor, a liquid crystal display (LCD), and a graphic card) that visualizes the various kinds of information, a device (such as a sound output device (a speaker, or the like)) that vocalizes the various kinds of information, and a device (such as a printing device) that converts the various kinds of information into characters. For example, the information processing device 10 may be configured to transmit information to other devices or receive information from other devices via the communication device 16.

The input device 14 and the output device 15 constitute a user interface that receives information from the user and presents information to the user.

The communication device 16 is a device that implements communication between other devices. The communication device 16 is a wired or wireless communication interface that implements communication with other devices via a communication network (the Internet, a local area network (LAN), a wide area network (WAN), a dedicated line, a public communication network, or the like), and is, for example, a network interface card (NIC), a wireless communication module, or a USB module.

For example, an operating system, a file system, a database management system (DBMS) (a relational database, NoSQL, or the like), a key-value store (KVS), or the like may be introduced into the information processing device 10.

The functions of the hypothesis evaluation system 1 are implemented by the processor 11 reading and executing a program stored in the main storage device 12, or by hardware (FPGA, ASIC, AI chip, and the like) constituting these devices. The hypothesis evaluation system 1 stores various kinds of information (data) as, for example, a database table or a file managed by a file system.

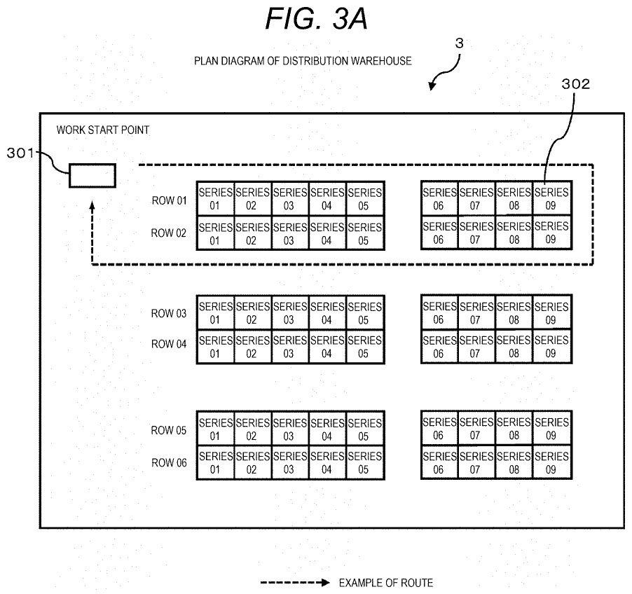

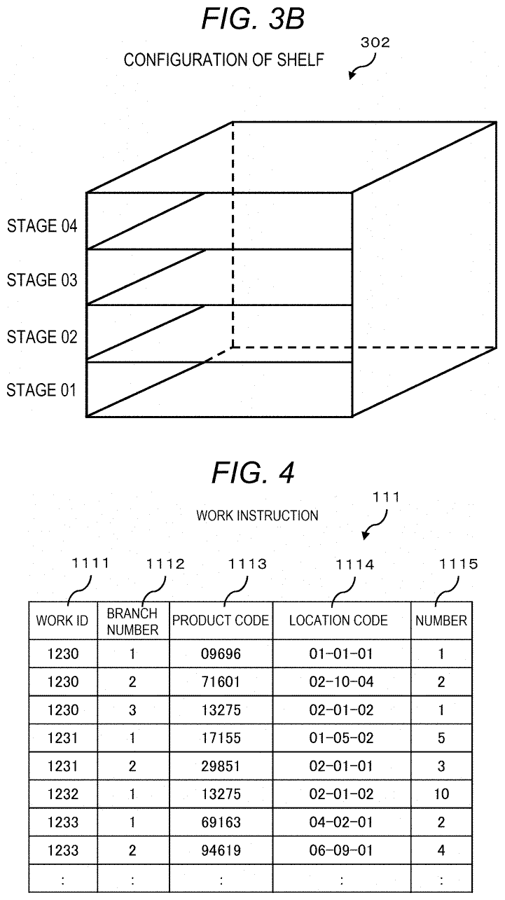

FIG. 3A is a plan diagram showing a state of an inside of a distribution warehouse 3 that is shown as an example of a site where the warehouse business is performed. FIG. 3B is a schematic diagram illustrating a structure of a shelf 302 arranged in the distribution warehouse 3 shown in FIG. 3A. As shown in FIG. 3B, the exemplified shelf 302 has four stages of stages “01” to “04”. As shown in FIG. 3A, a plurality of shelves 302 are arranged in the distribution warehouse 3. A work entity (a person, a robot, a transport device, or the like) can carry the product into or out of the shelf 302 from a passage facing the target shelf 302. A work start point 301 of shipping work is set in the distribution warehouse 3. According to the work instruction 111, the work entity departs from the work start point 301, and picks the product by sequentially tracing the shelves 302 in each of which a target product is stored. In the case of this example, in a row “01”, nine shelves 302 from a series “01” to a series “09” are arranged facing the passage. Similarly, nine shelves 302 are arranged in each of rows “02” to “06”.

FIG. 4 shows an example of the work instruction 111 described above. The work instruction 111 is created or generated, for example, by a person in charge of a distribution work, an information processing system for performing the distribution work, or the like, based on an order content received from a retail store, each consumer, or the like. The work instruction 111 includes information related to an instruction on a content of a specific work such as the shipping work performed by the work entity in the distribution warehouse 3.

As shown in FIG. 4, the exemplified work instruction 111 includes a plurality of entries (records) having items of a work ID 1111, a branch number 1112, a product code 1113, a location code 1114, and a number 1115. In the work ID 1111 among the entries, a work ID is set which is an identifier given to a group of works including a product-by-product work which is a work for each of one or more products. In the branch number 1112, a branch number of the work ID (a branch number for distinguishing the product-by-product work) is set. In the product code 1113, a product code which is an identifier of a product which is a target of the product-by-product work is set. In the location code 1114, a location code is set which is information for specifying a location where the product is placed. In the number 1115, the number of products which are targets of the product-by-product work is set.

In the case of the exemplified work instruction 111, for example, “1230” is set for the work ID 1111 on the first to third lines. The work under the work ID includes three product-by-product works distinguished by three branch numbers “1” to “3”. An instruction content of the work is to, first, pick one product with a product code “09696” and a branch number “1” from a location code “01-01-01”, then, pick two products with a product code “71601” and a branch number “2” from a location code “02-10-04”, and finally, pick one product with a product code “13275” and a branch number “3” from a location code “02-01-02”.

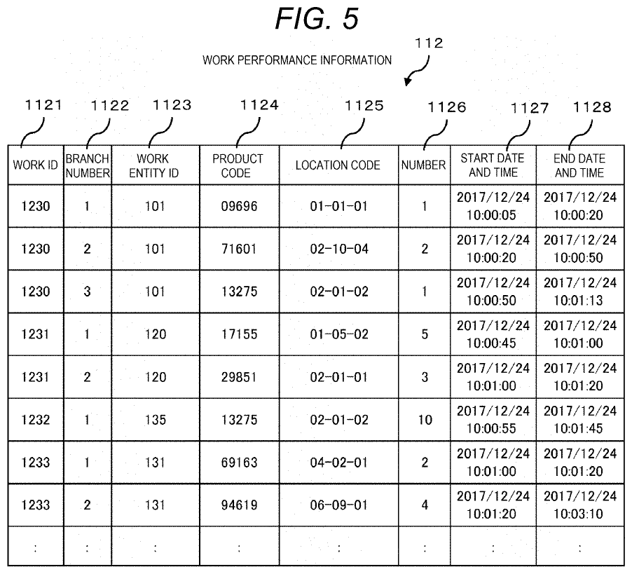

FIG. 5 shows an example of the work performance information 112 described above. The work performance information 112 includes the performance data described above. A content of the work performance information 112 is acquired by, for example, operating an information acquisition device such as a handy terminal when the work entity picks the product at a site.

As shown in FIG. 5, the work performance information 112 includes one or more entries (records) having items of a work ID 1121, a branch number 1122, a work entity ID 1123, a product code 1124, a location code 1125, a number 1126, a start date and time 1127, and an end date and time 1128. One entry of the work performance information 112 corresponds to one product-by-product work performed by the work entity.

In the work ID 1121, the above-described work ID is set. In the branch number 1122, the above-described branch number is set. In the product code 1124, a product code of the product which is the target of the product-by-product work is set. In the location code 1125, a location code is set which is information indicating a position where the product which is the target of the product-by-product work is placed. In the number 1126, the number of products which are targets of the product-by-product work is set. In the start date and time 1127, a date and time when the product-by-product work is started is set. In the end date and time 1128, a date and time when the product-by-product work is ended is set.

In the case of the exemplified work performance information 112, an entry with a branch number “1” and a work ID “1230” shows that a work entity with a work entity ID “101” starts a product-by-product work of picking one product with a product code “09696” from a location code “01-01-01” at “2017/12/24 10:00:05” and ends at “2017/12/24 10:00:20”.

In the actual distribution warehouse 3, for example, an order of picking may be changed instead of an order of the work ID or the branch number, or picking may be performed from a location where the number or the location code is different. Therefore, in addition to the exemplified items, the work performance information 112 may further include items representing events.

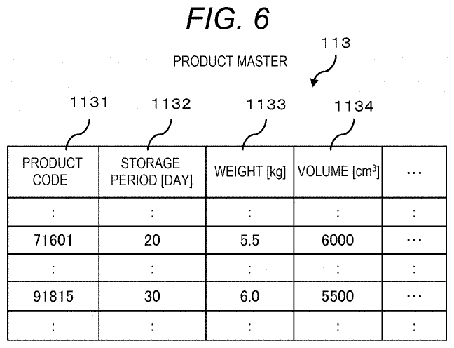

FIG. 6 shows an example of the product master 113 described above. The product master 113 manages information related to the product handled in the warehouse business. As shown in FIG. 6, the product master 113 includes a plurality of entries (records) having items of a product code 1131, a storage period 1132, a weight 1133, and a volume 1134.

In the product code 1131, the above-described product code is set. In the storage period 1132, a storage period of the product is set. In the weight 1133, a weight of the product is set. In the volume 1134, a volume of the product is set. In the case of the exemplified product master 113, an entry with a product code “71601” shows that a product has a storage period of “20 days”, a weight of “5.5 kg”, and a volume of “6000 cm³”.

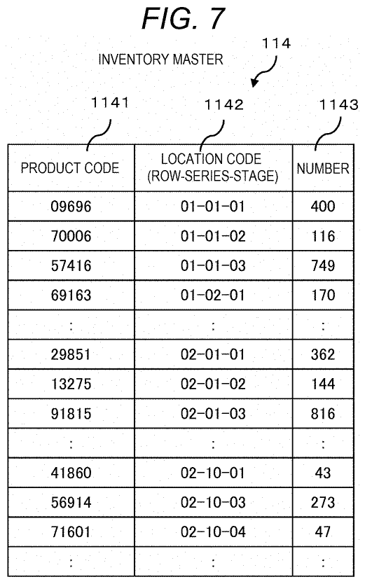

FIG. 7 shows an example of the inventory master 114 described above. The inventory master 114 manages information related to an inventory status of each product handled in the warehouse business at each location. As shown in FIG. 7, the inventory master 114 includes a plurality of entries (records) having items of a product code 1141, a location code 1142, and a number 1143.

In the product code 1141, the above-described product code is set. In the location code 1142, a location code of a location where the product is placed is set. In the number 1143, the number of products currently placed at the location is set. In the case of the exemplified inventory master 114, for example, an entry on the first line shows that “400” products with a product code “09696” are placed at a location code “01-01-01”.

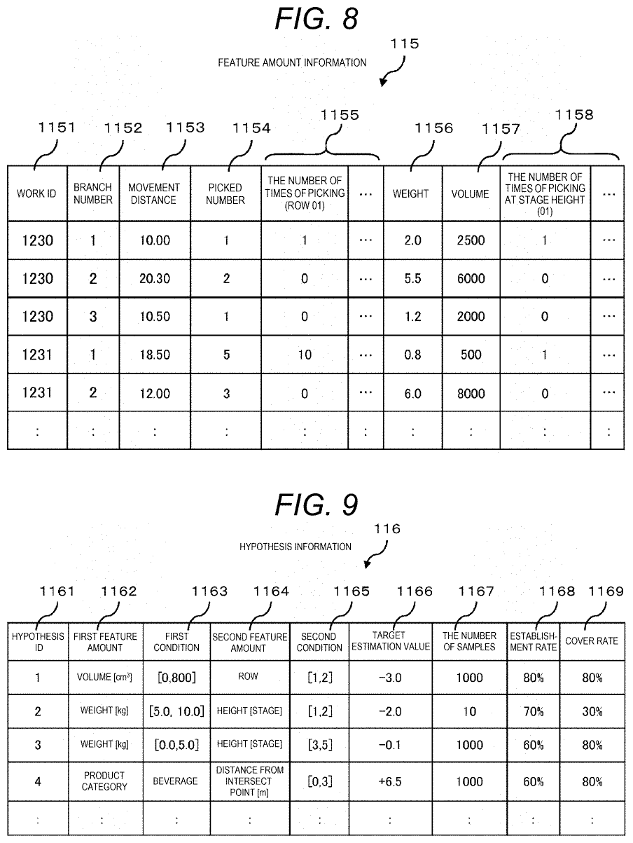

FIG. 8 shows an example of the feature amount information 115 described above. The feature amount information 115 is information referred to when the hypothesis is set, and includes information related to information (hereinafter, referred to as “feature amount”) obtained by associating the information in the work instruction 111, the product master 113, and the inventory master 114 with the information on each work specified by a combination of the work ID and the branch number in the work performance information 112. The exemplified feature amount is merely an example.

As shown in FIG. 8, the feature amount information 115 includes a plurality of entries (records) having items of a work ID 1151, a branch number 1152, a movement distance 1153, a picked number 1154, the number of times of picking (rows 01 to 09) 1155, a weight 1156, a volume 1157, and the number of piking at stage height (01 to 04) 1158.

In the work ID 1151, the above-described work ID is set. In the branch number 1152, the above-described branch number is set. In the movement distance 1153, a distance by which the work entity moves during the product-by-product work is set. The distance can be obtained as a theoretical value based on, for example, a flow line predetermined in the distribution warehouse 3. In the picked number 1154, the number of products picked in the product-by-product work is set. In the number of piking (rows 01 to 09) 1155, the number of times of picking for each row is set. In the weight 1156, the weight of the product that is the target of the product-by-product work is set. In the volume 1157, the volume of the product that is the target of the product-by-product work is set. In the number of times of picking at stage height (01 to 04) 1158, the number of times of picking at each stage height of the shelf 302 is set.

In the case of the exemplified feature amount information 115, for example, an entry in the first row shows that, in a work with a work ID “1230” and a branch number “1”, a movement distance is “10.00 m”, the picked number of times is “1”, the number of times of picking from a column “01” is “1”, a weight is “2.0 kg”, a volume is “2500 cm³”, and the number of times of picking from a stage height “01” of the shelf 302 is “1”. For example, by referring to the feature amount information 115, the user can grasp, for example, a combination of conditions of the feature amounts that improve or deteriorate the work time which is a KPI.

FIG. 9 shows an example of the hypothesis information 116 described above. The hypothesis information 116 manages information related to the hypothesis for the work that may change the efficiency (KPI: Key Performance Indicator) of the warehouse business. The hypothesis is set, for example, by the user based on the work performance information 112 and the feature amount information 115. For example, the user specifies a work that may change the efficiency of the warehouse business based on a small number of samples of the work performance information 112, and sets a hypothesis based on the specified work. In the present embodiment, a case where the hypothesis improves the efficiency of the warehouse business is exemplified, the hypothesis may however be a hypothesis that reduces the efficiency of the warehouse business (a hypothesis which should not be performed).

As shown in FIG. 9, the hypothesis information 116 includes one or more entries (records) having items of a hypothesis ID 1161, a first feature amount 1162, a first condition 1163, a second feature amount 1164, a second condition 1165, a target estimation value 1166, the number of samples 1167, an establishment rate 1168, and a cover rate 1169. One entry of the hypothesis information 116 corresponds to one hypothesis. The hypothesis is represented by two combinations of the feature amount of the product-by-product work and the condition for the feature amount. The number of combinations is not necessarily limited, and the number of combinations may be one or three or more.

Among the above items, in the hypothesis ID 1161, a hypothesis ID that is an identifier of the hypothesis is set. In the first feature amount 1162, one of the feature amounts acquired from the feature amount information 115 is set. In the first condition 1163, a first condition that is a condition set for the first feature amount is set. In the second feature amount 1164, another one of the feature amounts acquired from the feature amount information 115 is set. In the second condition 1165, a second condition that is a condition set for the second feature amount is set. In the target estimation value 1166, a target value of an estimation value (hereinafter, referred to as a “target estimation value”) is set which is a difference from a reference value of the work time which is a target index (KPI). The reference value is, for example, an average value of the work time estimated based on the performance data that does not satisfy any of the first condition and the second condition. In this case, when the estimation value is a negative number, it indicates that the work efficiency is improved. When the estimation value is a positive number, it indicates that the work efficiency is reduced.

All of the number of samples 1167, the establishment rate 1168, and the cover rate 1169 is information set by the hypothesis setting unit 160 based on the information acquired from the work performance information 112. In the number of samples 1187, the number of pieces of performance data (samples) that satisfy both the first condition 1163 and the second condition 1165 and that are acquired from the work performance information 112 is set. In the establishment rate 1168, an establishment rate is set which is a ratio of performance data, in which an estimation value is equal to or less than the target estimation value (for which the improvement in work efficiency is confirmed), to the performance data satisfying the first condition 1163 and the second condition 1165. In the cover rate 1169, a cover rate is set which is a ratio that the performance data satisfying the first condition 1163 and the second condition 1165 covers the first condition 1163 and the second condition 1165.

For example, the hypothesis (entry) with a hypothesis ID “2” in the second line of the exemplified hypothesis information 116 represents a hypothesis in which the work time is reduced by “2.0 seconds” (work efficiency is improved) by picking a product with a weight of 5.0 kg to 10.0 kg from a height of “1st and 2nd stages”. Further, “10” pieces of the performance data that satisfy the first condition and the second condition of the hypothesis exist, and the performance data that reduces the work time by “2.0 seconds” or more takes “70%” of the performance data satisfying the first condition and the second condition. The performance data satisfying the first condition and the second condition covers “30%” of a range specified by each of the first condition 1163 and the second condition 1165.

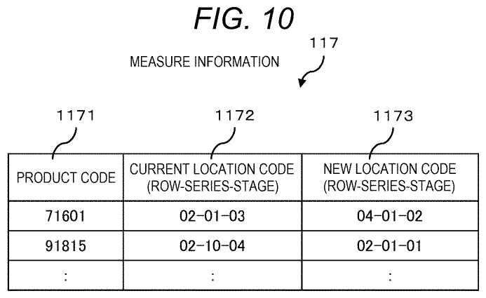

FIG. 10 shows an example of the measure information 117 described above. The measure information 117 manages information related to a measure generated based on the hypothesis information 116. As shown in FIG. 10, the measure information 117 includes one or more entries (records) having items of a product code 1171, a current location code 1172, and a new location code 1173.

In the product code 1171, a product code of a product which is a target of the product-by-product work is set. In the current location code 1172, a location code of a location where the product is currently placed is set. In the new location code 1173, a location code of a location of a movement destination of the product is set.

A first line in the exemplified measure information 117 shows that, based on the hypothesis with a hypothesis ID “2” shown in FIG. 9, that is, a hypothesis that shortens the work time when a product with a weight of “5.0 kg to 10 kg” is picked from a stage height of “1st and 2nd stages”, a product with the weight of “5.0 kg to 10.0 kg” is extracted from the product master, for example, a product with a product code “71601” is moved from a current location “02-01-03” to a new location “04-01-02”. It is preferable that the measure is set so as to cover a wide range of conditions as much as possible, for example, to cover a range of weight “5.0 to 10.0 kg” evenly.

Next, processing performed using the hypothesis evaluation system 1 will be described.

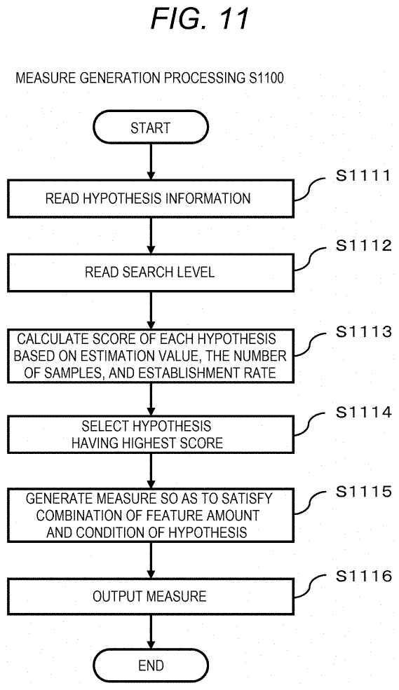

FIG. 11 is a flowchart illustrating processing (hereinafter, referred to as “measure generation processing S1100”) in which the measure generation unit 170 generates a measure based on the hypothesis information 116. The measure generation processing S1100 is executed, for example, by setting the hypothesis information 116 and then the user performing an operation to start the processing. Hereinafter, the measure generation processing S1100 will be described with reference to FIG. 11.

First, the measure generation unit 170 reads the content of the hypothesis information 116 (S1111).

Subsequently, the measure generation unit 170 reads a search level set in advance by the user (S1112). The search level is, for example, any value of “0” or more and “1” or less, and is used for calculation of a score referred to when the measure generation unit 170 selects, from the hypothesis information 116, a hypothesis to be evaluated.

Subsequently, the measure generation unit 170 calculates a score of each hypothesis included in the hypothesis information 1116 (S1113). For example, the measure generation unit 170 calculates, based on the estimation value, the number of pieces of performance data (hereinafter, referred to as “the number of samples”), and the establishment rate acquired from the hypothesis information 116, and using a value of the search level (hereinafter, referred to as “α”), the score by multiplying each value of (1−α)* estimation value, (−α)*log (the number of samples), and (−α)* establishment rate by a positive coefficient and then taking a sum thereof. Accordingly, for example, the score is low when the estimation value is high but the number of samples is sufficient or when the establishment rate is already high. The estimation value may be emphasized by adjusting the search level α. In addition, by adjusting the search level α, the influence of the number of samples and the establishment rate on the score may be adjusted.

Subsequently, the measure generation unit 170 selects one hypothesis having a highest score (S1114), generates a measure so as to satisfy each combination of the feature amount and the condition of the selected hypothesis (S1115), and outputs the measure information 117 including the generated measure (S1116).

The user reflects the content of the measure information 117, that is output as described above, in the work instruction 111. The hypothesis evaluation system 1 may automatically generate the work instruction 111 reflecting the content of the measure information 117.

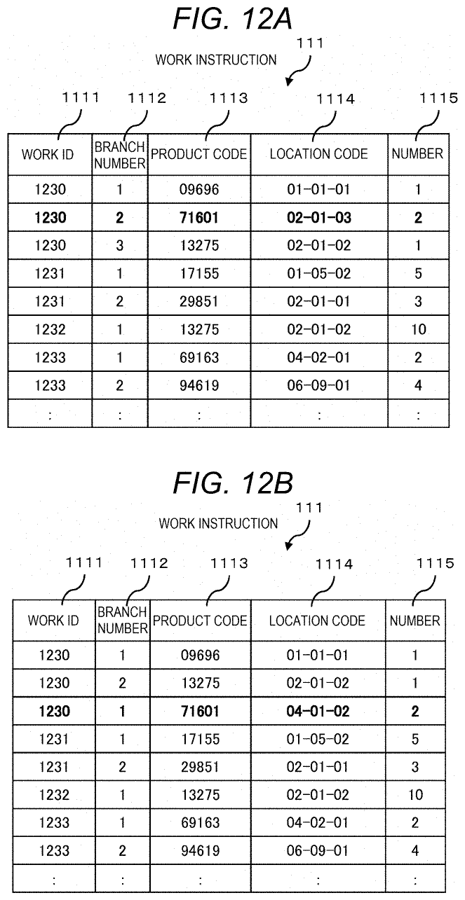

FIG. 12A shows an example of the work instruction 111 before the content of the measure information 117 is reflected therein. FIG. 12B shows an example of the work instruction 111 after the content of the measure information 117 is reflected in the work instruction 111 in FIG. 12A. In this example, a location of a product with a product code “71601” is changed from “02-01-03” to “04-01-02”.

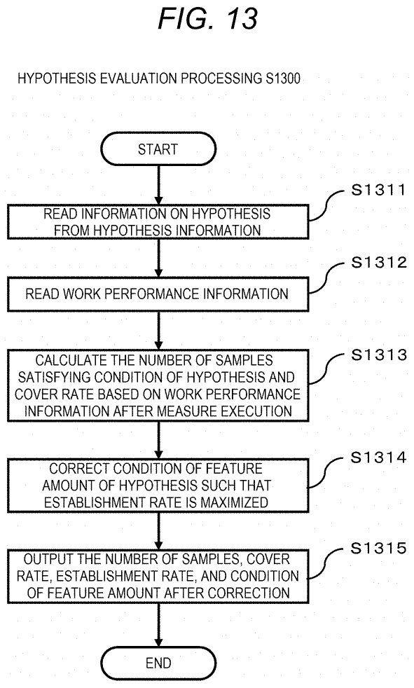

FIG. 13 is a flowchart illustrating processing (hereinafter, referred to as “hypothesis evaluation processing S1300”) in which the hypothesis evaluation unit 180 evaluates the hypothesis based on the work performance information 112 obtained by executing the measure generated in the measure generation processing S1100 in FIG. 11. In the hypothesis evaluation processing S1300, the hypothesis evaluation unit 180 corrects the combination of the feature amount and the condition such that each of the estimation value, the establishment rate, and the cover rate of the hypothesis are as large as possible. Hereinafter, the hypothesis evaluation processing S1300 will be described with reference to FIG. 13.

First, the hypothesis evaluation unit 180 reads, from the hypothesis information 116, information on the hypothesis for which the measure is actually executed (S1311).

Subsequently, the hypothesis evaluation unit 180 reads the content of the work performance information 112 after the measure is executed (S1312).

Subsequently, the hypothesis evaluation unit 180 specifies, based on the work performance information 112, performance data (sample) satisfying the condition of the feature amount of the read hypothesis, and calculates the number of samples and the cover rate (S1313). Here, the cover rate is an index indicating how much the specified performance data covers a region of a feature amount space defined by the combination of the feature amount and the condition of the hypothesis. For example, the cover rate can be defined as a ratio of the number of grids in which the performance data exists to all grids when the region is divided into grids of a constant size in a grid shape. In order to regard that the hypothesis is generally established, the cover rate needs to be a sufficiently high value.

Subsequently, the hypothesis evaluation unit 180 corrects the condition (the range of the feature amount) in the combination of the feature amount and the condition of the hypothesis such that the establishment rate is maximized (S1314). For example, the above correction method is a method of dividing the performance data into two regions which are a region that satisfies the condition of the feature amount and a region that does not satisfy the condition of the feature amount, comparing an average value of estimation values based on the performance data in the region that does not satisfy the condition with an estimation value of each performance data so as to determine whether or not the hypothesis is established, and correcting the condition.

Subsequently, the hypothesis evaluation unit 180 outputs the calculated number of samples, the cover rate, the establishment rate, and the condition (range of the feature amount) of the feature amount after correction as a hypothesis evaluation result (S1315).

In addition to the feature amount of the hypothesis, there may be other feature amounts (for example, “movement distance” in the warehouse business. Hereinafter, referred to as “important feature amount”) that have a great influence on the efficiency of the warehouse business. In this case, by simply comparing the performance data that satisfies the condition of the feature amount of the hypothesis and the performance data that does not satisfy the condition of the feature amount of the hypothesis as described above, it may not be possible to properly correct the condition of the feature amount of the hypothesis (range of the feature amount). Therefore, when the important feature amount exists, for example, the condition of the feature amount (range of the feature amount) is set as follows.

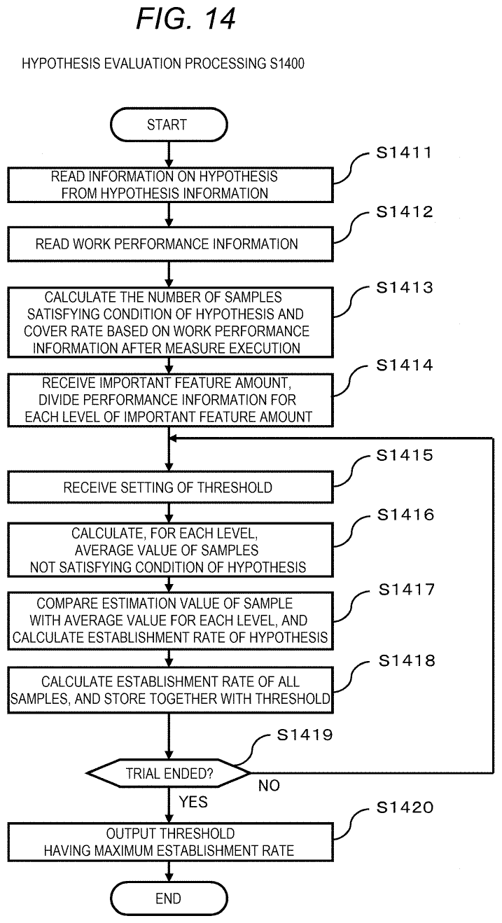

FIG. 14 is a flowchart illustrating another example of the hypothesis evaluation processing (hereinafter, referred to as “hypothesis evaluation processing S1400”) when the important feature amount exists. Hereinafter, the hypothesis evaluation processing S1400 will be described with reference to FIG. 14.

First, since processing in S1411 to S1413 is the same as that in S1311 to S1313 in FIG. 13, the description thereof is omitted.

In S1414, the hypothesis evaluation unit 180 receives setting of the important feature amount from the user, and sets a plurality of ranges (hereinafter, referred to as “level”) obtained by dividing a possible range of the received important feature amount (S1414).

Subsequently, the hypothesis evaluation unit 180 receives setting of a threshold from the user for the condition of the feature amount of the hypothesis (S1415).

Subsequently, the hypothesis evaluation unit 180 calculates, for each level, an average value of the performance data that does not satisfy the condition of the feature amount of the hypothesis (S1416).

Subsequently, the hypothesis evaluation unit 180 determines, for each level, whether or not the hypothesis is established for each piece of performance data by comparing the estimation value of the each piece of performance data with the efficiency of the performance data satisfying the conditions of the feature amount of the hypothesis, and calculates the establishment rate of the hypothesis (S1417). As described above, by calculating the establishment rate for each level obtained by dividing the possible range of the important feature amount, it is possible to accurately determine whether or not the hypothesis is established in the range where the important feature amounts are similar.

Subsequently, the hypothesis evaluation unit 180 calculates, based on the establishment rate calculated for each level, the establishment rate of all the performance data satisfying the condition of the hypothesis as, for example, an average value of each level or an average value obtained by weighting according to the number of samples of each level, and stores the calculated establishment rate together with the threshold (S1418).

Subsequently, the hypothesis evaluation unit 180 determines whether or not to stop the repeated processing from S1415 (S1419). On one hand, when the processing is not to be stopped (S1419: NO), the processing returns to S1415. On the other hand, when the processing is to be stopped (S1419: YES), the processing moves to S1420. The hypothesis evaluation unit 180 determines the stop based on, for example, whether or not the user performs a predetermined stop operation or whether or not the number of repetitions reaches a preset number of repetitions.

In S1420, the hypothesis evaluation unit 180 outputs a threshold (boundary value defining the range of the feature amount) corresponding to one establishment rate having a maximum value among the stored establishment rates.

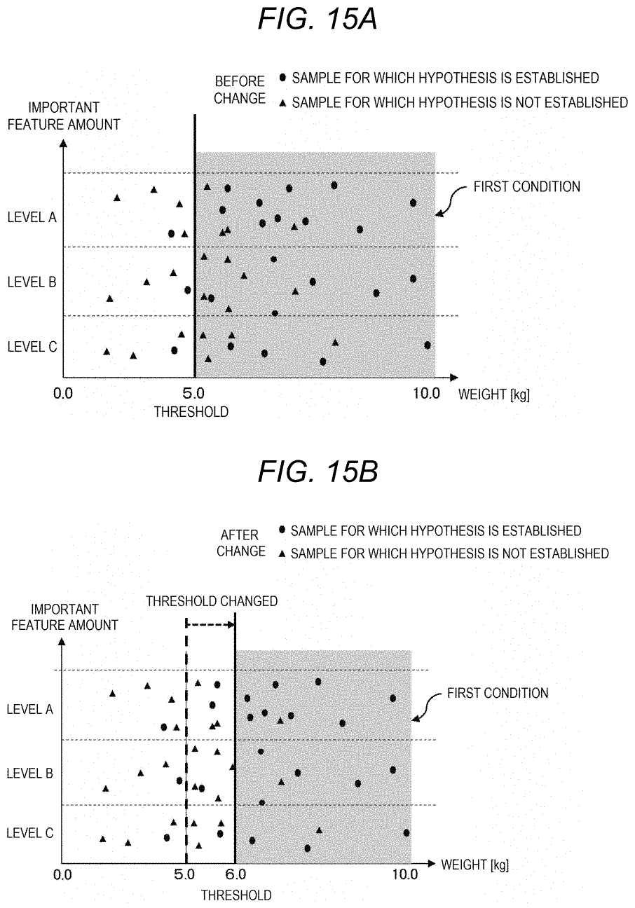

FIGS. 15A and 15B are graphs schematically showing states of setting the threshold in the hypothesis evaluation processing S1400 shown in FIG. 14. FIG. 15A is a graph showing a state before the threshold is changed. FIG. 15B is a graph showing a state after the threshold is changed. FIGS. 15A and 15B correspond to the hypothesis whose hypothesis ID in the hypothesis information 116 shown in FIG. 9 is “2”, a horizontal axis represents the “weight” set in the first feature amount 1162, and a vertical axis represents the important feature amount newly set by the user. The threshold to be changed is a threshold for the first condition set for the first feature amount. For ease of description, the second condition of the second feature amount 1164 is that the “height” is fixed to “1st and 2nd stages” (for the sample that satisfies the second condition).

As shown in FIG. 15A, before the threshold is changed, the first condition is set to “5 kg to 10 kg”. Black-painted circles shown in FIG. 15A are samples for which a hypothesis in which the estimation value is equal to or less than “−2.0” of the target estimation value 1166 is established. Black-painted triangles are samples for which the hypothesis is not satisfied. The hypothesis evaluation unit 180 calculates the hypothesis establishment rate for each level (level A, level B, and level C).

As shown in FIG. 15B, in the present example, in order to reduce the number of samples (black-painted triangles), for which the hypothesis is not established, existing in a region of the first condition of the hypothesis, and to improve the establishment rate, the threshold that determines the range (boundary) of the first condition is reset from “5.0” to “6.0”.

As described above in detail, according to the hypothesis evaluation system 1 in the present embodiment, it is possible to easily generate an appropriate measure for efficiently evaluating the hypothesis. In addition, it is possible to provide the information (the establishment rate, the cover rate, and the number of samples) for evaluating the hypothesis based on the result of executing the work including the generated measure. Therefore, the hypothesis can be evaluated efficiently and appropriately. In addition, for a work method that has little experience so far, it is possible to efficiently find a work method that has a good effect of improving the business efficiency, and it is possible to continuously improve the business efficiency.

Although the embodiment has been described above, the invention is not limited to the embodiment described above, and includes various modifications. The embodiment described above has been described in detail for easy understanding of the invention, and the invention is not necessarily limited to those including all the configurations described above. A part of the configuration of the embodiment may be added to, deleted from, and replaced with another configuration.

A part or all of the configurations, functions, processing units, processing methods or the like described above may be implemented by hardware such as using an integrated circuit for designing. Further, the invention can also be implemented by a program code of software that implements each function described in the embodiment. In this case, a storage medium recording the program code is provided to an information processing device (computer), and a processor of the information processing device reads out the program code stored in the storage medium. In this case, the program code itself read out from the storage medium implements the functions of the embodiment described above, and the program code itself and the storage medium storing the program code constitute the invention. Examples of the storage medium for supplying the program code include a hard disc, a solid state drive (SSD), an optical disk, a magneto-optical disc, a CD-R, a flexible disc, a CD-ROM, a DVD-ROM, a magnetic tape, a non-volatile memory card, a ROM, or the like.

Further, in the above embodiment, a control line and an information line are considered to be necessary for description, and all control lines and information lines are not necessarily shown in a product. All configurations may be connected to each other. In the above description, various kinds of information are exemplified in a table format, whereas these kinds of information may be managed in a format other than a table format.

What is claimed is:

1. A hypothesis evaluation system implemented using an information processing device, the hypothesis evaluation system configured to:
store, for a work whose efficiency is desired to be improved, a hypothesis defined by using, as elements, one or more combinations of a feature amount representing the work and a condition imposed on the feature amount, and a target index of the efficiency;
generate a plurality of measures in which a value of the feature amount is set around a threshold that determines a range of the feature amount so as to satisfy the condition;
store an estimation value of the efficiency for each of the measures, the estimation value being acquired by executing the measure;
compare the estimation value with the target index to determine whether or not the hypothesis is established for each of the measures; and
set the threshold based on a result of the determination.

2. The hypothesis evaluation system according to claim 1, comprising:
a user interface configured to receive the setting of the threshold while presenting information based on the result of the determination.

3. The hypothesis evaluation system according to claim 1, wherein
a plurality of pieces of performance data each being acquired by executing work including the measure and being information indicating a performance of the work are stored,
the estimation value is calculated based on each of the plurality of pieces of performance data, and
as information based on the result of the determination, an establishment rate that is a ratio of the performance data, in which the hypothesis is established, to the performance data satisfying the condition is output.

4. The hypothesis evaluation system according to claim 1, wherein
a plurality of pieces of performance data each being acquired by executing work including the measure and being information indicating a performance of the work are stored, and
as information based on the result of the determination, a cover rate that is a ratio that the performance data satisfying the condition covers the range is output.

5. The hypothesis evaluation system according to claim 1, wherein
a plurality of pieces of performance data each being acquired by executing work including the measure and being information indicating a performance of the work are stored, and
as information based on the result of the determination, the number of pieces of performance data satisfying the condition is output.

6. The hypothesis evaluation system according to claim 1, wherein
a plurality of pieces of performance data each being acquired by executing work including the measure and being information indicating a performance of the work are stored,
a possible range of another feature amount different from the feature amount which is the element of the hypothesis is divided into a plurality of levels,
the setting of the threshold for the feature amount which is the element of the hypothesis is received,
for each of the levels, an average value of the performance data that does not satisfy the condition for the feature amount which is the element of the hypothesis is calculated,
for each of the levels, the estimation value calculated based on the performance data is compared with the average value to calculate an establishment rate that is a ratio of the performance data, in which the hypothesis is established, to the performance data satisfying the condition, and
the establishment rate for all the plurality of pieces of performance data is calculated based on the establishment rate calculated for each of the levels, and a threshold is set such that the calculated establishment rate is maximized.

7. The hypothesis evaluation system according to claim 6, comprising:
a user interface configured to receive designation of another feature amount.

8. The hypothesis evaluation system according to claim 1, wherein
a plurality of hypotheses are stored,
a plurality of pieces of performance data each being acquired by executing the work and being information indicating a performance of the work are stored,
an estimation value is calculated based on each of the plurality of pieces of performance data,
for each of the plurality of hypotheses, an establishment rate that is a ratio of the performance data, in which each of the hypotheses is established, to the performance data satisfying the condition is calculated,
a hypothesis is selected based on at least one of the estimation value, the establishment rate, and the number of pieces of performance data satisfying the condition in each of the hypotheses, and
for the selected hypothesis, generation of the measure, acquisition of the estimation value, determination on whether or not the hypothesis is established, and generation of the threshold based on the result of the determination are performed.

9. A hypothesis evaluation method performed by an information processing device comprising:
storing, for a work whose efficiency is desired to be improved, a hypothesis defined by using, as elements, one or more combinations of a feature amount representing the work and a condition imposed on the feature amount, and a target index of the efficiency;
generating a plurality of measures in which a value of the feature amount is set around a threshold that determines a range of the feature amount so as to satisfy the condition;
storing an estimation value of the efficiency for each of the measures, the estimation value being acquired by executing the measure;
comparing the estimation value with the target index to determine whether or not the hypothesis is established for each of the measures; and
setting the threshold based on a result of the determination.

10. The hypothesis evaluation method according to claim 9, further comprising:
storing a plurality of pieces of performance data each being acquired by executing work including the measure and being information indicating a performance of the work;
dividing a possible range of another feature amount different from the feature amount which is the element of the hypothesis into a plurality of levels;
receiving the setting of the threshold for the feature amount which is the element of the hypothesis;
calculating, for each of the levels, an average value of the performance data that does not satisfy the condition for the feature amount which is the element of the hypothesis;
comparing, for each of the levels, the estimation value calculated based on the performance data with the average value to calculate an establishment rate that is a ratio of the performance data, in which the hypothesis is established, to the performance data satisfying the condition; and
calculating the establishment rate for all the plurality of pieces of performance data based on the establishment rate calculated for each of the levels and setting a threshold such that the calculated establishment rate is maximized.

11. The hypothesis evaluation method according to claim 9, further comprising:
storing a plurality of hypotheses;
storing a plurality of pieces of performance data each being acquired by executing the work and being information indicating a performance of the work;
calculating an estimation value based on each of the plurality of pieces of performance data;
calculating, for each of the plurality of hypotheses, an establishment rate that is a ratio of the performance data, in which each of the hypotheses is established, to the performance data satisfying the condition;
selecting a hypothesis based on at least one of the estimation value, the establishment rate, and the number of pieces of performance data satisfying the condition in each of the hypotheses; and
performing, for the selected hypothesis, generation of the measure, acquisition of the estimation value, determination on whether or not the hypothesis is established, and generation of the threshold based on the result of the determination.
